(19) United States
(12) Patent Application Publication
(10) Pub. No.: US 2007/0101870 A1
(43) Pub. Date: May 10, 2007

(54) Structure of tea ball

(76) Inventors: Su Rong Liu, Taipei (TW); Shiou Jen Yang, Taipei (TW)

Correspondence Address: RABIN & BERDO, P.C., Suite 500, 1101 14 Street, N.W., Washington, DC, 20005, US

(21) Appl. No.: 11/416,073

(22) Filed: May 3, 2006

(30) Foreign Application Priority Data
Nov. 4, 2005 (TW) 094219134

(51) Int. Cl. A47J 43/14

(52) U.S. Cl. 99/495

(57) ABSTRACT

The “structure of tea ball” comprises of a tea caddy and an infuser. The infuser features a convex bottom, with screens on the bottom as well as hooks on the edge of the top opening. And, the tea caddy features a groove on the edge of the bottom opening and a plastic seal. A tea ball is formed while hooking the infuser to the groove of the tea caddy. This invention addresses a design that allows users to carry the tea ball anywhere. Besides, construction of this invention provides a scientific way to brew the tea healthily.

### BACKGROUND OF THE INVENTION

I. Field of the Invention

This invention relates to a “structure of tea ball”, comprising of a tea caddy and an infuser, is adaptive for usage to the common tea tumbler. It is easy to carry and use, as well as conforming to the attribute of health science in brewing tea.

II. Description of the Prior Art

Generally to brew tea, the tea leaves are usually placed in the teapot, subsequently flushing the hot water therein. In this way, hardly anybody could bring the tea pot along to brew tea anywhere. To rectify the deficiencies thereof, an infuser basket FIG. 1 was thus invented. The top opening element thereof features a supportive convex A, a connective concave B as well as sieves C on the body thereof. Fit the lid into connective concave B. However, construction of such infuser basket FIG. 1 makes it not easy to use, carry and store, especially where it causes EGCG of tea to be oxygenized. The oxygenized EGCG makes the tea lose its flavor. Objective of this invention is to rectify the deficiencies of foregoing infuser basket.

### SUMMARY OF THE INVENTION

The present invention refers to a “structure of tea ball” that can improve the deficiencies of foregoing infuser basket.

Objective of this invention is to introduce a tea ball adaptive for usage to a common tea tumbler whichever, especially to keep the flavor of tea by retaining its EGCG. Besides, the construction of tea ball of this invention makes it easy to use and carry.

To achieve the foregoing objective, the “structure of tea ball” of this invention comprises of an infuser and a tea caddy. The infuser features a convex bottom, screen on the bottom, as well as hooks on the edge of the top opening. The tea caddy also features a convex top, groove on the edge of bottom opening as well as a plastic seal.

Tear off the plastic seal on the bottom opening of tea caddy to pour the tea leaves into the infuser. Hook the infuser to groove of the tea caddy to form a tea ball. Drop the tea ball into a tea tumbler. In addition to effectively retain the EGCG of tea, the construction of this invention also makes it easy to use and carry.

### BRIEF DESCRIPTION OF THE DRAWINGS

FIG. 1 is construction of the existing infuser basket.

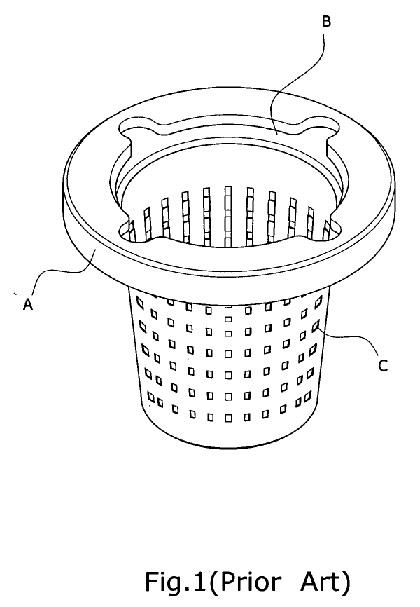

FIG. 2 is diagram of tea ball of this invention.

FIG. 3 is construction of tea ball of this invention.

FIG. 4 is tea ball of this invention in a common tea tumbler.

FIG. 5 is diagram of integrated tea tumbler of this invention.

FIG. 6 is construction of integrated tea tumbler of this invention.

### DESCRIPTION OF THE PREFERRED EMBODIMENT

Further aspects, objects, and desirable features of the invention will be better understood from the detailed description and drawings, with a better embodiment of the disclosed invention being illustrated by way of examples, as follow:

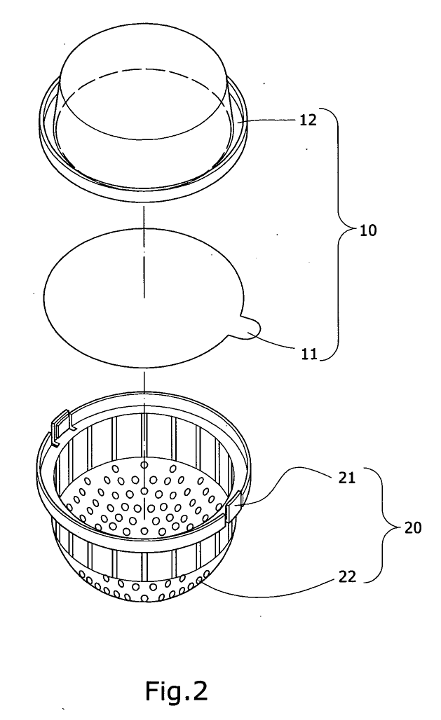

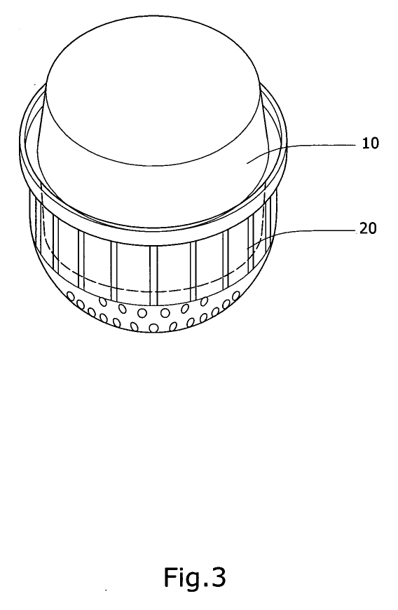

Referring to FIGS. 2 and 3, the “structure of tea ball” of this invention comprises of a lid-typed tea caddy 10 and an infuser 20. The infuser 20 features a convex bottom, hooks 21 on the edge of top opening as well as screens 22 on the bottom. And, the tea caddy 10 features a convex top, groove 12 on the edge of bottom opening as well as a plastic seal 11. A tea ball is formed while fastening the infuser with its hooks 21 to groove 12 of the tea caddy 10. Construction of this invention is adaptive to the usage of a common tea tumbler.

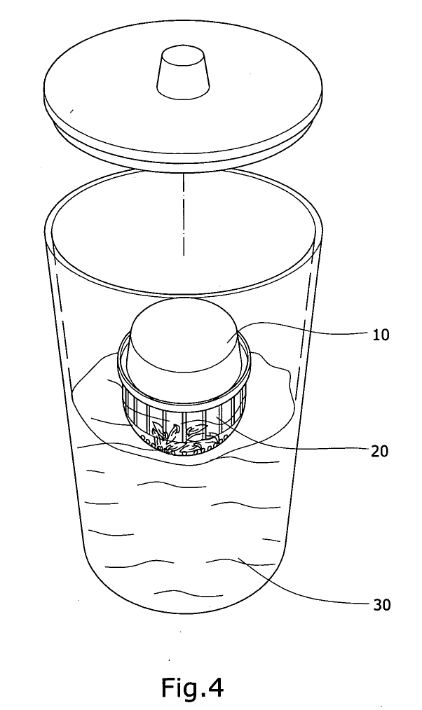

Referring to FIGS. 2 and 4, tear off the plastic seal 11 on bottom of the tea caddy 10 to pour the tea leaves into the infuser 20. Fasten the infuser 20 with its hooks 21 to groove 12 of the tea caddy 10 to form a tea ball. In this way, the tea caddy 10 becomes a lid to the infuser 20. Drop the tea ball into a tea tumbler 30 with hot water. The infuser 20 shall be horizontally balanced because the tea caddy 10 serve as a lid thereby keeping the air inside. And, the tea leaves are completely immersed in the hot water that flows in and out of infuser 20 through screens 22. This is how the EGCG is retained to consequently reserve the flavor of tea. Besides, this invention presents the functions of easy carrying and usage.

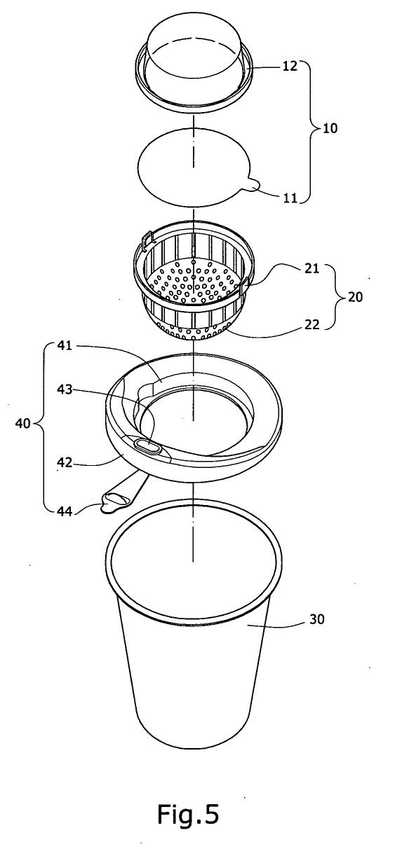

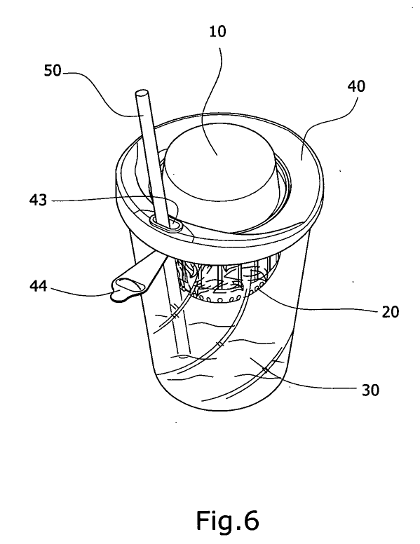

Referring to FIGS. 5 and 6, a joint ring 40 on the tea tumbler 30, designed to park the tea ball, features a supportive element 41, a connective element 42, a spout as well as a tap 44. Assemble the joint ring 40, tea ball and tea tumbler 30 per following steps. Firstly, clip the connective element 42 of joint ring 40 to the tea tumbler 30. Secondly, park the tea ball composed of tea caddy 10 and infuser 20 therein while clipping the groove 12 of tea caddy 10 to connective element 41 of joint ring 40. Subsequently, the tea leaves are completely immersed in the hot water that flows in and out of infuser 20 through screens 22. After few minutes, open the tap 44 to insert a straw 50 through spout 43 to drink the tea. The tap 44 is a device covering the spout 43 to keep the tea from spilling. It also effectively blocks air circulation to retain the EGCG of tea. This integrated tea tumbler can be carried anywhere.

To sum up, the “structure of tea ball” and integrated tea tumbler of this invention is easy to use and carry. This invention is “practical” and “advanced”. Submission of this invention is to register the patents thereof according to the patent law.

### NOTATIONS

10—lid-typed tea caddy
20—infuser
30—tea tumbler
40—joint ring
50—straw
11—plastic seal
12—groove
21—hook
22—screen
41—supportive element
42—connective element
43—spout
44—tap

What is claimed is:

1. A type of “structure of tea ball” comprising of a lid-typed tea caddy and an infuser. The infuser features a convex bottom, screens on the bottom as well as hooks on the edge of top opening. In addition, the tea caddy features a groove on the edge of bottom opening and a plastic seal. A tea ball is formed while hooking the infuser to the groove of the tea caddy.

2. The “structure of tea ball” of claim 1, wherein the tea ball composed of tea caddy and infuser can park on a joint ring. The joint ring features a supportive element, a connective element, a spout as well as a tap. The tea ball is parked while clipping the groove of tea caddy to connective element of joint ring.
